(19) United States
(12) Patent Application Publication
(10) Pub. No.: US 2008/0267488 A1
(43) Pub. Date: Oct. 30, 2008

(54) Apparatus and method for monitoring overlapped object

(75) Inventors: Yuan-Chi Lin, Hsin-Chu City (TW); Shih-Fang Lin, Hsin-Chu City (TW)

Correspondence Address: SINORICA, LLC, 528 FALLSGROVE DRIVE, ROCKVILLE, MD, 20850, US

(73) Assignee: King Yuan Electronics Co., Ltd.

(21) Appl. No.: 11/979,514

(22) Filed: Nov. 5, 2007

(30) Foreign Application Priority Data
Apr. 27, 2007 (CN) 096115036

(51) Int. Cl. G06K 9/00

(52) U.S. Cl. 382/145

(57) ABSTRACT

An apparatus and a method for monitoring overlapped objects are disclosed. The monitoring apparatus comprises a projection device and a camera for projecting images to a target plane at different angles and shooting the pictures from the target plane. When an object is placed on the target plane, the pictures present the part of the image overlapping the surface of the object for determining whether there are overlapped objects or not.

### FIELD OF THE INVENTION

The present invention relates to a semiconductor tester, and more particularly, to a semiconductor tester equipped with AOI function for monitoring overlapped objects and its monitoring method.

### DESCRIPTION OF THE PRIOR ART

In semiconductor post process, when the DUTs are under test, they are first put in the input/output section of semiconductor tester, then transferred onto the tray, and then delivered to the test section by a pick-and-place device one by one or group by group to go through test process. After the test process, the DUTs are placed on trays on tray shelves for qualified and defective products separately according to the test results.

Chips on trays are usually arranged in array. However, in the transferring or arranging process, more than one chip may be placed at the same position on the tray for certain reasons and thus results in two or more than two overlapped chips at the same position. Similar problems occur when the chips are delivered from the input/output section to the test section or from the test section to the input/output section. The chips look alike and they cannot be easily recognized when they are overlapped, especially when they are hid in an array of chips. Thus a better design is needed to help solve the problem of overlapped objects.

### SUMMARY OF THE INVENTION

In view of the needs and profits of the industry as mentioned above, one main purpose of the present invention is to provide an apparatus and a method for monitoring overlapped objects to achieve what prior testers cannot achieve.

Accordingly, the present invention provides an apparatus for monitoring overlapped objects, which comprises a projection device, a camera, and a display device, wherein the display device displays a plurality of critical lines. The projection device projects a visible light source to a target plane at an angle. The camera shoots pictures of the visible light source and transmits the pictures to a CPU. The pictures are processed by the CPU and then displayed on the display device. Changes of position of visible light source displayed on the display device are examined to determine whether there are overlapped objects or not.

Moreover, the present invention further provides a method for monitoring overlapped objects, comprising: providing at least a critical line; providing a DUT; providing a laser light to shine on the DUT; providing a camera to shoot visible laser light on the DUT and to display the position of the visible laser light; then performing a determining process to determine the relative positions of the visible laser light and the critical line, determining that there are overlapped objects at the position when the visible laser light passes beyond the critical line; performing monitoring and determining process of next DUT when the visible laser light does not pass beyond the critical line.

### BRIEF DESCRIPTION OF THE DRAWINGS

FIG. 1 is a diagram schematically showing the apparatus for monitoring overlapped objects of the present invention.

FIG. 2 is a diagram schematically showing the configuration of base line and edge line of the apparatus for monitoring overlapped objects of the present invention.

FIG. 3 is a diagram schematically showing the configuration of critical line for determining overlapped objects of the apparatus for monitoring overlapped objects of the present invention.

FIG. 4 is a diagram schematically showing the determination of overlapped objects of the apparatus for monitoring overlapped objects of the present invention.

FIG. 5 is a flow diagram schematically showing the method for determining overlapped objects of the present invention.

### DETAILED DESCRIPTION OF THE PRESENT INVENTION

The present invention relates to an apparatus and a method for monitoring overlapped objects. In order to describe the present invention more thoroughly, the composition of the apparatus and each step in the method will be described in detail. Apparently, details well known to those skilled in the art of testers are not limited in the application of the present invention. On the other hand, the well-known knowledge regarding the composition of tester and the steps of operation would not be described in detail to prevent from arising unnecessary interpretations. Preferred embodiments of the present invention will be described in detail in the following. However, in addition to the embodiments described, the present invention can also be applied extensively in other embodiments and the scope of the present invention is not limited and only determined by the appended claims.

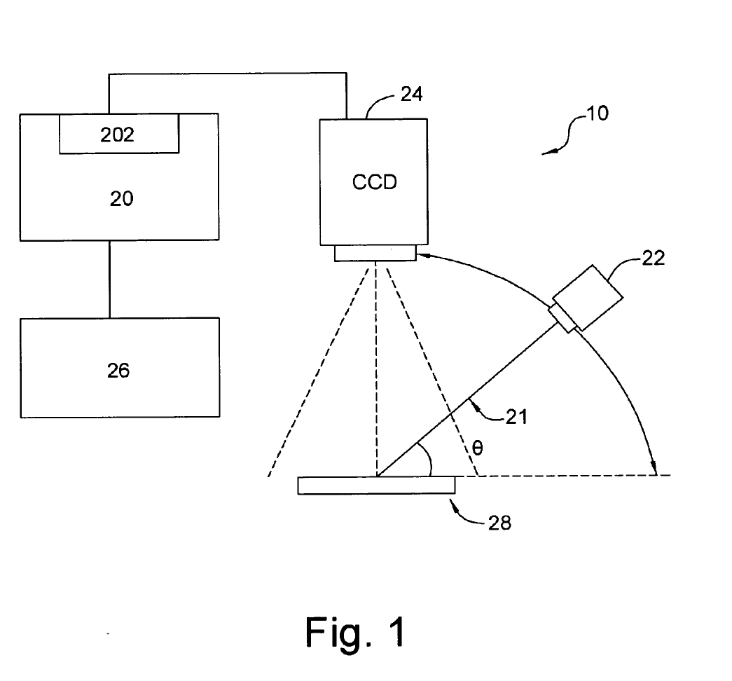

First, referring to FIG. 1, which is a diagram of an apparatus for monitoring overlapped objects of the present invention. As shown in FIG. 1, the apparatus for monitoring overlapped objects 10 of the present invention comprises a projection device 22, a camera 24, a CPU 20, and a display device 26. The projection device 22 is used to provide a visible light source 21. The projection device 22 projects the light emitted by the visible light source 21 on the target plane 28 at an adjustable angle (θ). The camera 24 shoots the same target plane 28 at a fixed angle, and transmits images shot to an image processing unit 202. Gray level image signals are acquired and transferred into digital image data, which are transmitted to CPU 20 to be compared and analyzed. Images processed by CPU 20 are displayed by display device 26 at the same time.

Moreover, the projection device 22 in the present invention can be a laser device, especially a laser device emitting a light beam. The camera 24 can be a device composed of light sensitization element such as charge coupling device (CCD) or CMOS sensor. The display device can be a flat panel display, an oscilloscope, or a projector. Furthermore, the target plane can be a tray. The CPU 20 can be a PC, and the image processing unit 202 can be combined with the CPU 20. What is to be emphasized here is that the CPU 20 in the present invention is a CPU equipped with AOI function.

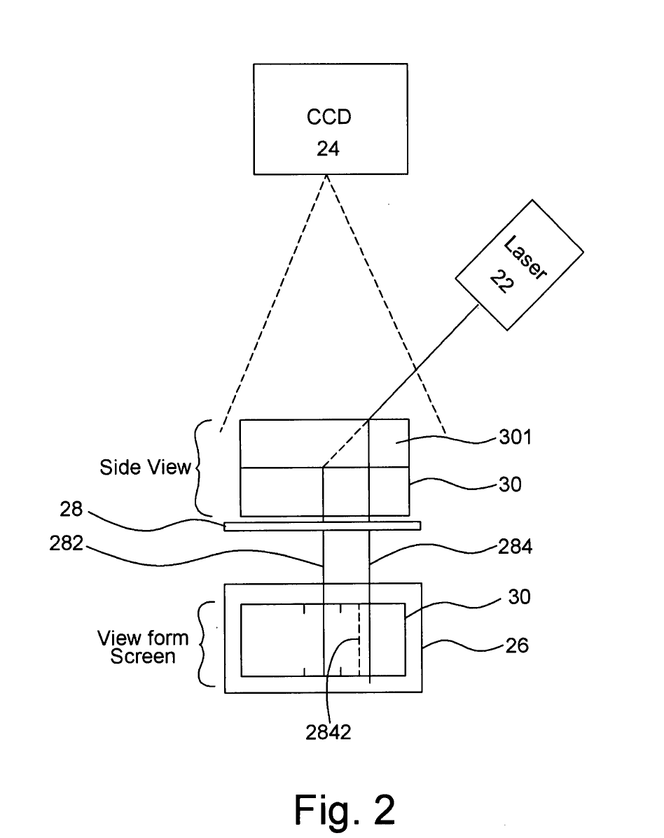

Then, referring to FIG. 2, which is a diagram showing the setting of critical line of the apparatus for monitoring overlapped objects of the present invention. First, a DUT 30 is placed on the target plane 28 of the apparatus for monitoring overlapped objects 10; for example, a semiconductor chip under test is placed on the tray. Then, the visible light source 21 on the projection device 22 shines on the DUT 30 at a selected fixed angle and a projection line 282 is produced. At the same time the camera 24 shoots and transmits the images of DUT 30 and the projection line 282 on the DUT 30 to the image processing unit 202 from a fixed angle, i.e. a right angle to the target plane 28, and the transmitted gray level signals are transferred to digital signals. The transferred digital signals are then transmitted to CPU 20 to be processed. Thus, the projection line 282 is configured as a base line by CPU 20 after the calculation and processing of AOI. In a preferred embodiment of the present invention, the projection line 282 is configured near the central position of DUT 30. A same DUT 301 is then overlapped on DUT 30 and the visible light source 21 on the projection device 22 shines on the topmost DUT 301. The projection line 282 is offset and another projection line 284 is produced. This projection line 284 is the edge line of overlapped objects. Moreover, since DUT 30 has a certain thickness (or height), the operator can figure out the position of edge line according to the thickness of DUT 30 when the projection line 282 is configured as the base line by the operator.

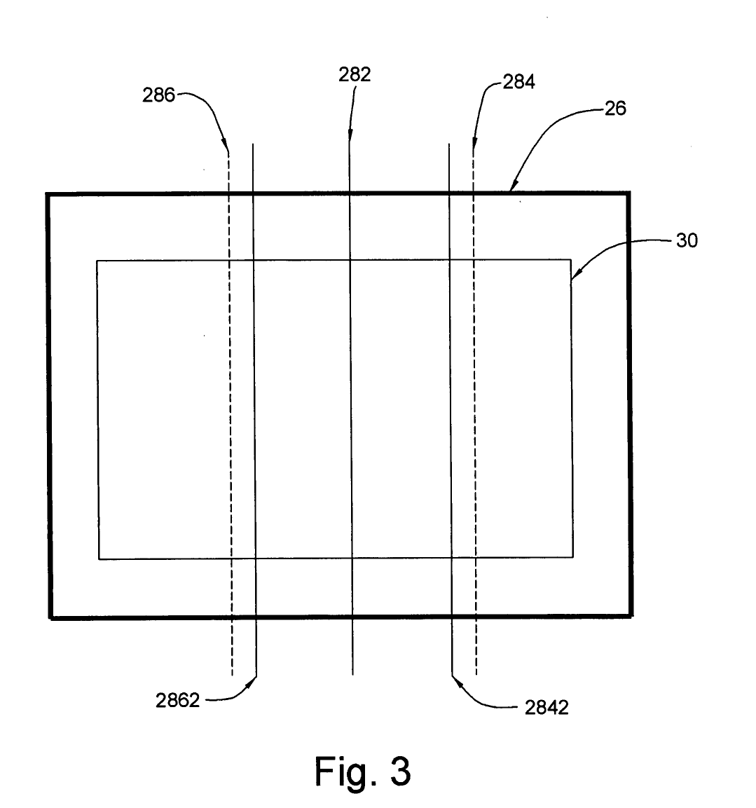

Then, referring to FIG. 3, which is a diagram showing the setting of the critical line of overlapped objects of the present invention. In the present embodiment, the above-mentioned projection line 282 is configured as base line 282, and the above-mentioned projection line 284 is configured as edge line 284. As what is described above, after the base line 282 and the edge line 284 are marked by the apparatus for monitoring overlapped objects 10, a critical line 2842 will be further defined in a preferred embodiment of the present invention for determining whether there are overlapped objects or not in order to avoid some operator interface problems such as errors caused by thickness of chip or levelness of tray that lead to misidentification or false alarm. In other words, in practical operation, only critical line 2842 is displayed on the display device 26 of the apparatus for monitoring overlapped objects 10. The base line 282 and edge line 284 are not displayed since they are only reference lines in the process of defining the critical line 2842. In the present invention, an error can be defined by the operator according to experience or by the CPU according to previous statistics and used as a reference while defining the critical line 2842.

Similarly, after the base line 282, the edge line 284, and the critical line 2842 are defined, another edge line 286 and critical line 2862 can be defined on the opposite side of base line 282 with the base line 282 as center, as shown in FIG. 3. Apparently, the critical line 2862 serves as the basis for determination when DUT 30 is not on the target plane.

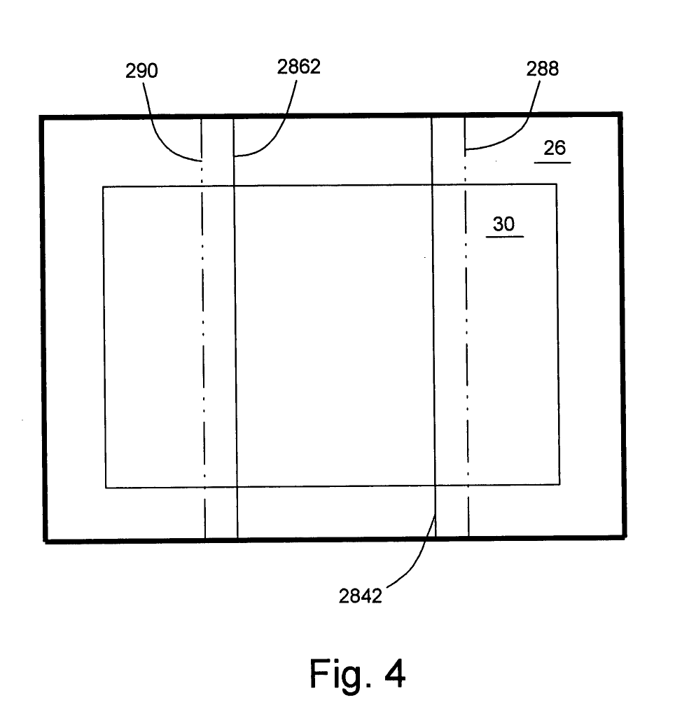

Then, referring to FIGS. 1 and 4 at the same time, which are diagrams showing the determination of overlapped objects of the apparatus for monitoring overlapped objects 10 of the present invention. When the projection device 22 of the apparatus for monitoring overlapped objects 10 emits a visible light laser on the DUT 301, a visible light laser beam 288 is displayed on the display device 26. When the position of the visible light laser beam 288 is on the right side of the critical line 2842 (as shown in FIG. 4), it indicates that there are overlapped DUTs 30 at this position. At this moment, the apparatus for monitoring overlapped objects 10 sends alarm or terminates the process. When the visible light laser is emitted on DUT 30 and the position of visible light laser beam 288 is on the left side of the critical line 2842, the situation is normal and the apparatus for monitoring overlapped objects 10 continues to perform the determination of next DUT 30. On the other hand, when the position of visible light laser beam 290 is on the left side of the critical line 2862 (as shown in FIG. 4), it indicates that there is no DUT 30 at this position.

What is to be emphasized again is that since all the projection lines displayed on the display device 26 (including lines 282, 284, and 2842) are processed by AOI system in CPU 20 and the positions of each projection line are recorded, thus in an embodiment of the present invention, when the position of visible light laser beam 288 is beyond the critical line 2842, CPU 20 presently determines that there are overlapped objects at the position and sends a signal. The signal is sent to suspend the testing process to perform elimination or to record the position-indicating signal of overlapped DUTs 30 for being processed after the testing process is ended. If it is determined that there is no DUT 30 on the target plane, the position-indicating signal can also be recorded for further process after the testing process.

Moreover, referring to FIG. 1, the thickness of DUT 30 may change according to the size of product. For example, if DUT 30 is too thin, the edge line of visible light source 21 will be too centralized; if the chip is too thick, the edge line will pass beyond the display device 26. The configuring process of critical line may be obstructed or the visible light laser beam 288 may pass beyond the display range of the display device during the operation due to the above-mentioned situations. In order to avoid these problems, the angle (θ) of the projection device 22 in the present invention is adjustable. The adjustable range can be from 0 degree to 90 degrees, and the preferred adjustable range is from 5 degrees to 85 degrees. When DUT 30 is a small, thin chip, the angle of projection device 22 can be adjusted to be a smaller degree, for example, 15 degrees; when DUT 30 is a bigger and thicker chip, the angle of projection device 22 can be adjusted to be a larger degree, for example, 75 degrees, so that the visible light laser beam 288 (or visible light laser beam 290) does not pass beyond the display range of the display device but at a proper position on the display device when DUTs are overlapped.

Furthermore, conventional semiconductor chip testers have input/output section and test section. DUTs waiting to be tested are placed in the tray of input/output section and wait to be delivered to the test section. In the test section, the handler (not shown in the diagram) picks up DUT 30 (a chip for example) in the tray and places it on the test socket to be tested. After the test, the handler picks up the chip and places it in another tray. When the apparatus for monitoring overlapped objects 10 of the present invention is combined with a tester, the apparatus for monitoring overlapped objects 10 can be installed in the input section, in the output section, or in both sections, and the CPU 20 in the apparatus for monitoring overlapped objects 10 can be installed in the tester. Moreover, an illumination device (not shown in the diagram) is further included in another embodiment of the present invention for illuminating the target plane 28 so that images of DUT 30 and visible light laser beam 288 (or visible light laser beam 290) shot by the camera 24 can be clearer. This illumination device can be installed between the camera 24 and the target plane 28, or opposite the side adjacent or opposite to the projection device 22. Wherein when the illumination device is installed between the camera 24 and the target plane 28, at least an opening has to be provided for the beams of camera 24 and projection device 22 to go through. In addition, the illumination device can be a bulb, LED array, or other light sources that illuminate, which is not limited in the present invention.

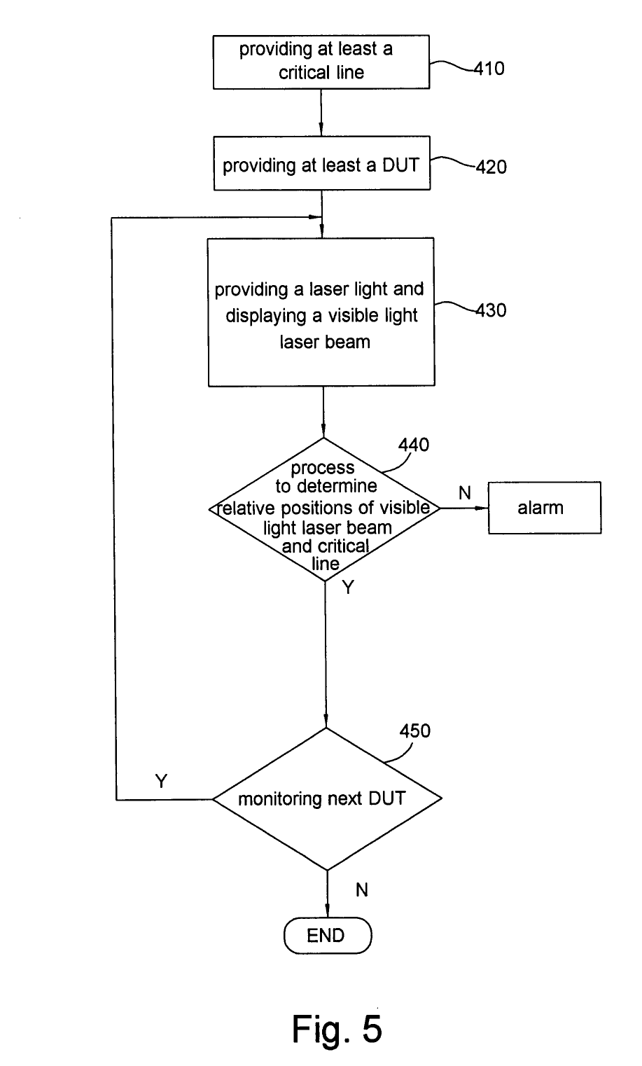

Then, referring to FIG. 5, which is a flow diagram showing the method for monitoring overlapped objects of the present invention. First, as shown in step 410, at least a critical line (2842; 2862) is provided on the display device 26. Then, as shown in step 420, a tray is provided to carry at least a DUT 30, and the tray carrying at least a DUT 30 is delivered to the apparatus for monitoring overlapped objects 10. And then, as shown in step 430, a laser light is provided to be projected on DUT 30, pictures of visible light laser beam 288 on DUT 30 are acquired by the camera 24 and processed by CPU 20, and the position of visible light laser beam 288 is displayed on the display device 26. Then, as shown in step 440, the relative positions of visible light laser beam 288 and critical line 2842 are determined; when the visible light laser beam 288 passes beyond the critical line 2842 (i.e. on the right side of critical line 2842, as shown in FIG. 4), the apparatus for monitoring overlapped objects 10 determines that there are overlapped DUTs at the position and sends an alarm or terminates the process; when the visible light laser beam 288 does not pass beyond the critical line 2842 (i.e. on the left side of critical line 2842), the apparatus for monitoring overlapped objects 10 determines that there are no overlapped objects at the position and the situation is normal and performs the monitoring and determining process of next DUT 30, as shown in step 450.

Apparently, the method for monitoring overlapped objects can also be used to determine whether there is DUT 30 at certain positions or not in the monitoring process. For example, when the visible light laser beam 290 passes beyond the critical line 2862 (i.e. on the left side of the critical line 2862, as shown in FIG. 4), the apparatus for monitoring overlapped objects 10 determines that there is not DUT 30 at the position and makes a record or terminates the process.

While the present invention has been described by way of examples and in terms of the preferred embodiments, it is to be understood that the present invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for monitoring overlapped objects, comprising:
a projection device for providing a visible light source to shine on a target plane;
a camera for shooting said target plane; and
a CPU for configuring the position of at least a critical line, receiving image data transmitted by said camera, recording and comparing the positions of said visible light source and said critical line, and performing determining process after comparing.

2. The apparatus for monitoring overlapped objects according to claim 1, wherein said CPU comprises an image processing unit.

3. The apparatus for monitoring overlapped objects according to claim 1, wherein said CPU is equipped with AOI function.

4. The apparatus for monitoring overlapped objects according to claim 1, wherein said projection device is a laser light source.

5. The apparatus for monitoring overlapped objects according to claim 1, wherein said camera can be a device composed of light sensitization element.

6. The apparatus for monitoring overlapped objects according to claim 1, wherein the angle of said camera can be adjusted between 5 degrees and 85 degrees.

7. The apparatus for monitoring overlapped objects according to claim 1, wherein the angle of said camera can be at 90 degrees to the target object.

8. The apparatus for monitoring overlapped objects according to claim 1, further comprising a display device for receiving and displaying image data transmitted by said CPU, wherein said display device can display the position of said critical line.

9. The apparatus for monitoring overlapped objects according to claim 8, wherein said display device can be chosen from a flat panel display, an oscilloscope, and a projector.

10. A tester with apparatus for monitoring overlapped objects, said tester comprising a CPU, input/output section, test section and at least an apparatus for monitoring overlapped objects, wherein said apparatus for monitoring overlapped objects comprises:
a projection device for providing a visible light source to shine on a target plane;
a camera for shooting said target plane; and
a display device for receiving and displaying image data transmitted by said CPU;
wherein said CPU further configures the position of at least a critical line and sends the critical line to said display device to be displayed, receives image data transmitted by said camera, records and compares the positions of said visible light source and said critical line, and performs a determining process after comparing.

11. The tester according to claim 10, wherein said CPU comprises an image processing unit.

12. The tester according to claim 10, wherein said CPU is equipped with AOI function.

13. The tester according to claim 10, wherein said camera can be a device composed of light sensitization element.

14. The tester according to claim 10, wherein said projection device can be a laser light source.

15. The tester according to claim 10, wherein said display device can be chosen from a flat panel display, an oscilloscope, and a projector.

16. The tester according to claim 10, wherein the angle of said camera can be adjusted between 5 degrees and 85 degrees.

17. The tester according to claim 10, wherein the angle of said camera can be at 90 degrees to the target object.

18. The tester according to claim 10, further comprising an illumination device installed between said camera and said target plane.

19. The tester according to claim 18, wherein said illumination device further comprises at least an opening for visible light beam of said projection device to go through.

20. A determining method for monitoring overlapped objects, comprising:
providing at least a critical line;
providing at least a DUT;
providing a laser light to be projected on DUT;
acquiring visible light laser beam on DUT and displaying the position of said visible light laser beam;
performing a determining process to determine relative positions of said visible light laser beam and said critical line;
determining that there are overlapped objects at the position when said visible light laser beam passes beyond said critical line; performing monitoring and determining process of next DUT when said visible light laser beam does not pass beyond said critical line.
